(19) United States
(12) Patent Application Publication
(10) Pub. No.: US 2009/0138556 A1
(43) Pub. Date: May 28, 2009

(54) SYSTEM AND METHOD FOR IMPLEMENTING QUICK RESPONSE REPLIES ON A DATA PROCESSING SYSTEM

(76) Inventors: Kevin M. Corry, Pflugerville, TX (US); Mark A. Peloquin, Austin, TX (US); Steven Pratt, Leander, TX (US); Karl M. Rister, Austin, TX (US); Andrew M. Theurer, Austin, TX (US)

Correspondence Address: DILLON & YUDELL LLP, 8911 N. CAPITAL OF TEXAS HWY.,, SUITE 2110, AUSTIN, TX, 78759, US

(21) Appl. No.: 11/945,299

(22) Filed: Nov. 27, 2007

(51) Int. Cl. G06F 15/16

(52) U.S. Cl. 709/206

(57) ABSTRACT

A system and method for implementing quick response replies on a data processing system. According to an embodiment of the present invention, a user drafts a current message within a current window of an instant messaging (IM) client, wherein the current message is targeted to a current user. In response to receiving a new message when the current message is partially drafted, the user drafts a new reply message to respond to the new message while preserving the partially-drafted message. The IM client sends the new reply message to respond to the new message. The user completes the partially-drafted current message and the IM client sends the completed current message to the current user.

### BACKGROUND OF THE INVENTION

1. Technical Field

The present invention relates in general to the field of data processing systems and in particular, to the field of exchanging messages between data processing systems on a network.

2. Description of the Related Art

Since the advent of the Internet, one of the most popular applications has been the use of electronic mail (e-mail) to quickly and cost-effectively send messages around the world. Instant messaging, which enables users to chat in real time, has revolutionized communication over the Internet. Text messaging has also enabled users to send quick messages to other users over a cellular network. Recently, there has been an intersection between instant messaging and text messaging. Users can send text and instant messages utilizing computers, cellular phones, or any other type of wired or wireless device.

### SUMMARY OF THE INVENTION

The present invention includes a system and method for implementing quick response replies on a data processing system. According to an embodiment of the present invention, a user drafts a current message within a current window of an instant messaging (IM) client, wherein the current message is targeted to a current user. In response to receiving a new message when the current message is partially drafted, the user drafts a new reply message to respond to the new message while preserving the partially-drafted message. The IM client sends the new reply message to respond to the new message. The user completes the partially-drafted current message and the IM client sends the completed current message to the current user.

The above, as well as additional objectives, features, and advantages of the present invention, will become apparent in the following detailed written description.

### BRIEF DESCRIPTION OF THE FIGURES

The invention itself, as well as a preferred mode of use, further objects, and advantages thereof, will best be understood by reference to the following detailed description of an illustrative embodiment when read in conjunction with the accompanying drawings, wherein:

FIG. 1 is a block diagram illustrating an exemplary network in which an embodiment of the present invention may be implemented;

FIG. 2 is a block diagram depicting an exemplary data processing system in which an embodiment of the present invention may be implemented;

FIG. 3 is pictorial representations of an instant messaging (IM) client interface in which an embodiment of the present invention may be implemented; and

FIG. 4 is a high-level logical flowchart illustrating an exemplary method for implementing quick response replies on a data processing system according to an embodiment of the present invention.

### DETAILED DESCRIPTION OF AN ILLUSTRATIVE EMBODIMENT

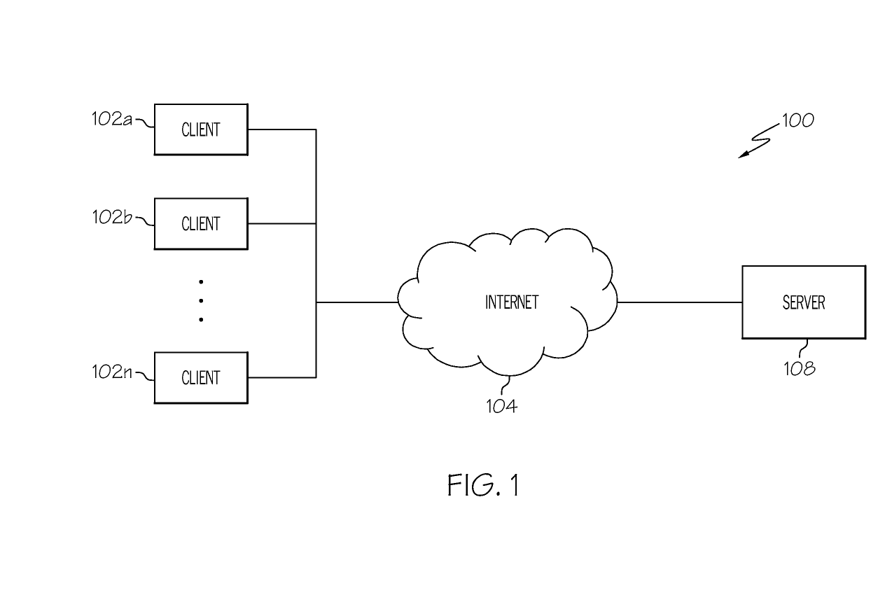

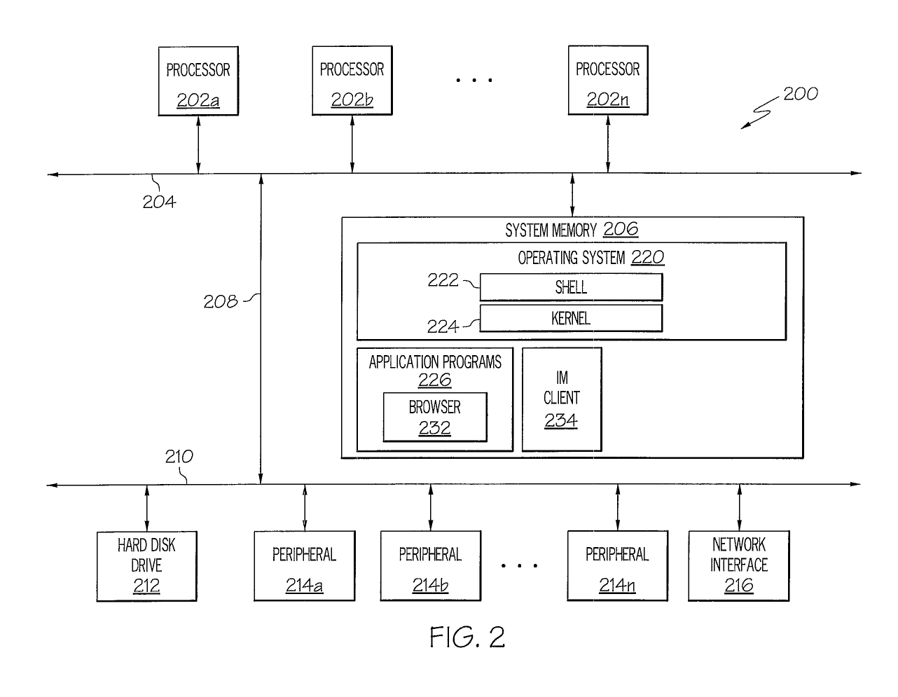

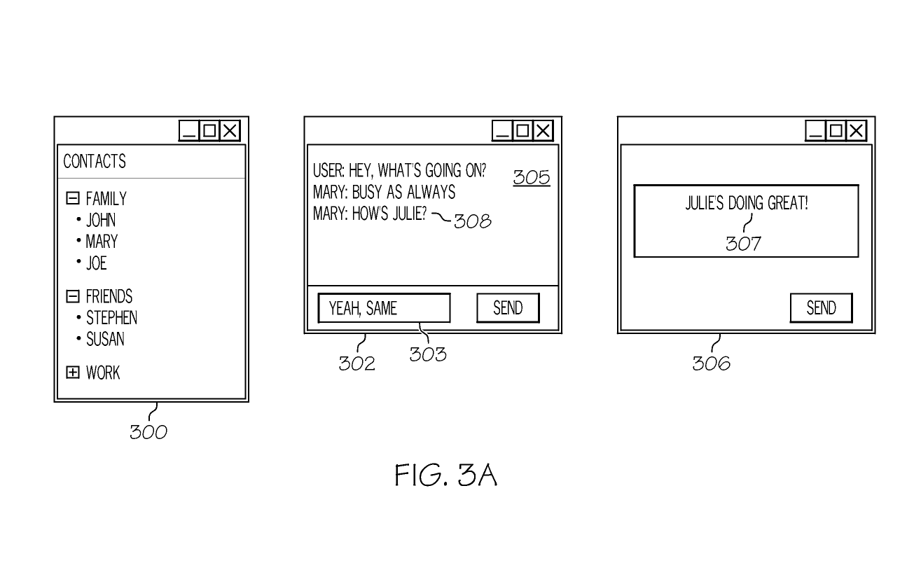

Referring now to the figures, and in particular, referring to FIG. 1, there is illustrated a block diagram depicting an exemplary network 100 in which an embodiment of the present invention may be implemented. As depicted, network 100 includes a collection of clients 102a-102n, Internet 104, and server 106. Clients 102a-102n are coupled to server 106 via Internet 104. While Internet 104 is utilized to couple clients 102a-102n to server 106, those with skill in the art will appreciate that a local-area network (LAN) or wide-area network (WAN) utilizing Ethernet, IEEE 802.11x, or any other communications protocol may be utilized. Clients 102a-102n and server 106 are discussed herein in more detail in conjunction with FIG. 2. According to an embodiment of the present invention, clients 102a-102n may utilize a browser stored in system memory to send and receive information to and from server 106. The information may include e-mails, web pages, and the like. Those with skill in the art will appreciate that exemplary network 100 may include other components such as routers, firewalls, etc. that are not germane to the discussion of the present network and will not be discussed further herein.

FIG. 2 is a block diagram depicting an exemplary data processing system 200, which may be utilized to implement clients 102a-102n and server 106 as shown in FIG. 1. As illustrated, exemplary data processing system 200 includes a collection of processors 202a-202n that are coupled to a system memory 206 via a system bus 204. System memory 206 may be implemented by dynamic random access memory (DRAM) modules or any other type of random access memory (RAM) module. Mezzanine bus 208 couples system bus 204 to peripheral bus 210. Coupled to peripheral bus 210 is a hard disk drive 212 for mass storage and a collection of peripherals 214a-214n, which may include, but are not limited to, optical drives, other hard disk drives, printers, and input devices, and the like. Network interface 216 enables data processing system 200 to communicate on a network, such as, but not limited to Internet 104.

Included in system memory 206 is operating system 220, which further includes a shell 222 (as it is called in the UNIX® operating system, which is a registered trademark of The Open Group in the United States and other countries), for providing transparent user access to resources such as application programs 226. Shell 222, also called a command processor in Microsoft® Windows® operating system, is generally the highest level of the operating system software hierarchy and serves as a command interpreter. Microsoft® and Windows® are trademarks of Microsoft Corporation in the United States, other countries, or both. Shell 222 provides a system prompt, interprets commands entered by keyboard, mouse, or other input media, and sends the interpreted command(s) to the appropriate lower levels of the operating system (e.g., kernel 224) for processing. Note that while shell 222 is a text-based, line-oriented user interface, the present invention will support other user interface modes, such as graphical, voice, gestural, etc. equally well.

As illustrated, operating system 220 also includes kernel 224 which includes lower levels of functionality for operating system 220 and application programs 226, including memory management, process and task management, disk management, and mouse and keyboard management. Application programs 226 can include browser 228, utilized for access to Internet 104 (FIG. 1), word processors, spreadsheets, and other application programs. System memory 206 also includes instant messaging (IM) client 234 for enabling the exchange of instant messages between clients on network 100.

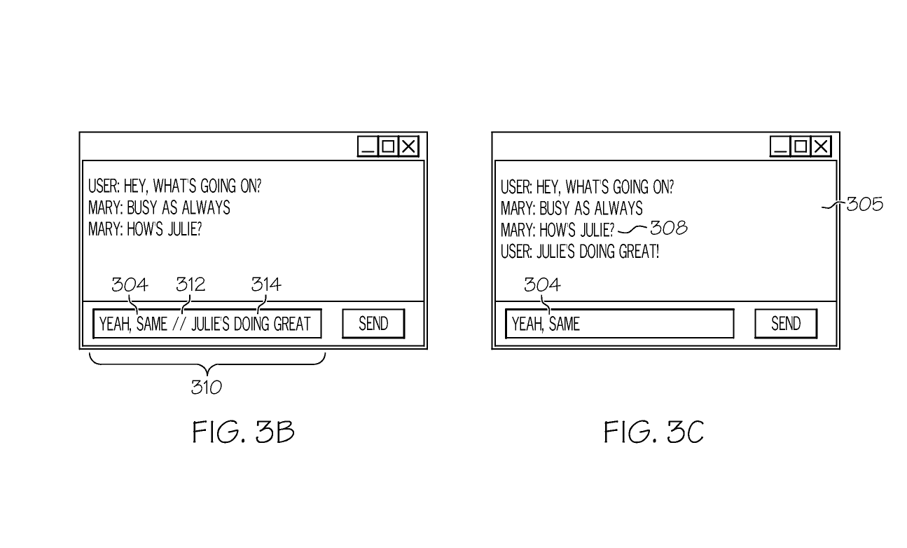

FIG. 3 depicts pictorial representations of various graphical user interfaces (GUIs) of IM client 234 as depicted in FIG. 2. According to an embodiment of the present invention, the GUI of IM client 234 includes a contact list 300. As shown, contact list 300 includes a collection of contacts with which a user can exchange messages. In some embodiments of the present invention, contact list 300 can be further organized into more specific groups like, for example, “family”, “friends”, and “work”.

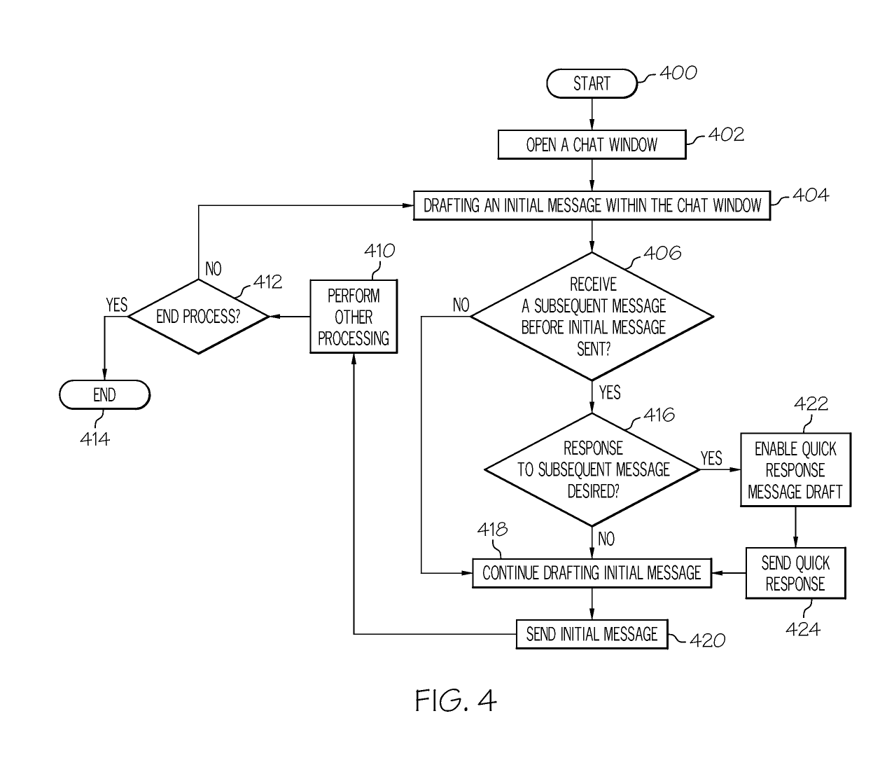

According to an embodiment of the present invention, to begin an instant message chat session, a user selects a name from contact list 300 and opens a chat window 302. Chat window 302 includes chat log 305, which illustrates the exchanged messages and text input area 303, which enables a user to type instant messages. Quick reply window 306 (discussed herein in more detail in conjunction with FIG. 4) enables a user to send a quick response to a message that was received during the drafting of a current message.

For exemplary purposes, assume that a user has begun a chat session with Mary, as illustrated in FIG. 3. Chat log 305 shows that the user has sent a message “Hey, what's going on” to Mary. In response, Mary wrote “Busy as always”. As the user is drafting a response (“Yeah, same . . . ”) 304 to Mary's “Busy as always” response, assume for exemplary purposes that Mary sent a message 308 that states “How's Julie?”. The user was drafting a message 304 to respond to Mary's “Busy as always” response, but was interrupted by Mary's “How's Julie?” message 308. Instead of erasing partially-drafted response 304, the user invokes a quick response window 306 and types a quick response 307 (“Julie's doing great!”) in quick response window 306. After sending the quick response 307 (“Julie's doing great!”), the user closes quick response window 306 and chat window 302 resembles FIG. 3, which illustrates partially-drafted response 304 in text input area 303 and quick response 307 appearing in chat log 305 under Mary's message 308 (“How's Julie?”).

According to another embodiment of the present invention, once the user receives Mary's message 308 (“How's Julie?”) before partially-drafted response 304 is sent, the user can create a combined message 301 in text input area 303. Combined message includes partially-drafted response 304, quick response character 312, and quick response 314. When the user wishes to send quick response 314, IM client 234 (FIG. 2) parses combined message 310 for quick response character 312, which indicates to IM client 234 the beginning of quick response 314. As illustrated quick response character 312 can be implemented as a double-slash “//”, but those with skill in the art will appreciate that quick response character 312 may be implemented by any character or combination of characters. IM client 234 (FIG. 2) sends quick response 314 and leaves partially-drafted response 304 within text input area 303, as indicated in FIG. 3.

FIG. 4 is a high-level logical flowchart illustrating an exemplary method for implementing quick response replies on a data processing system according to an embodiment of the present invention. The process begins at step 400 and continues to step 402, which illustrates a user opening a chat window 302 (FIG. 3) of IM client 234 (FIG. 2). The process continues to step 404, which depicts a user drafting the current message within chat window 302 (FIG. 3). The process continues to step 406, which shows IM client 234 (FIG. 2) determining if a subsequent message has been received by the user before the current message has been sent. If so, the process continues to step 416, which illustrates IM client 234 (FIG. 2) determining if a response to the subsequent message (received by the user before the current message has been sent) is desired by the user. If not, the process continues to step 418, which depicts the user continue drafting the current message in chat window 302 (FIG. 3). Once the user completes the draft of the current message, the process continues to step 420, which shows the user sending the current message within chat window 302 (FIG. 3). The current message is displayed in chat log 305 (FIG. 3). The process then continues to step 410, which illustrates IM client 234 (FIG. 2) performing other processing.

Returning to step 416, if a response to the subsequent message is desired by the user, the process continues to step 422, which illustrates IM client 234 (FIG. 2) enabling a the drafting of a quick response message. As previously discussed in conjunction with FIG. 3, one embodiment of the present invention enables the user to open a quick response window 306 (FIG. 3) to draft a quick response message. According to another embodiment of the present invention, the user can insert a quick response character 312 (FIG. 3) and type the quick response after quick response character 312 (FIG. 3). The process continues to step 424, which depicts IM client 234 (FIG. 2) sending the quick response. The process then continues to step 418.

Returning to step 406, if IM client 234 (FIG. 2) determines that a subsequent message has not been received by the user before the current message has been sent, the process continues to step 418, which depicts the user continue drafting the current message in chat window 302 (FIG. 3). Once the user completes the draft of the current message, the process continues to step 420, which shows the user sending the current message within chat window 302 (FIG. 3). The current message is displayed in chat log 305 (FIG. 3). The process continues to step 410, which illustrates IM client 234 (FIG. 2) performing other processing. The process continues to step 412, which shows IM client 234 (FIG. 2) determining if the process should end. The user could signify the end of the process by closing chat window 302 (FIG. 3). If the process should not end, the process returns to step 404. If the process is to end, the process ends, as illustrated in step 414.

As discussed, the present invention includes a system and method for implementing quick response replies on a data processing system. According to an embodiment of the present invention, a user drafts a current message within a current window of an instant messaging (IM) client, wherein the current message is targeted to a current user. In response to receiving a new message when the current message is partially drafted, the user drafts a new reply message to respond to the new message while preserving the partially-drafted message. The IM client sends the new reply message to respond to the new message. The user completes the partially-drafted current message and the IM client sends the completed current message to the current user. Those with skill in the art will appreciate that the present invention is not limited to an IM client on a computer system, but may include text message clients on cellular (or other portable telephone) networks.

It should be understood that at least some aspects of the present invention may alternatively be implemented in a computer-usable medium that contains a program product. Programs defining functions in the present invention can be delivered to a data storage system or a computer system via a variety of signal-bearing media, which include, without limitation, non-writable storage media (e.g., CD-ROM), writable storage media (e.g., hard disk drive, read/write CD-ROM, optical media), system memory such as, but not limited to random access memory (RAM), and communication media, such as computer networks and telephone networks, including Ethernet, the Internet, wireless networks, and like networks. It should be understood, therefore, that such signal-bearing media, when carrying or encoding computer-readable instructions that direct method functions in the present invention, represent alternative embodiments of the present invention. Further, it is understood that the present invention may be implemented by a system having means in the form of hardware, software, or a combination of software and hardware as described herein or their equivalent.

While the present invention has been particularly shown and described with reference to a preferred embodiment, it will be understood by those skilled in the art that various changes in form and detail may be made herein without departing from the spirit and scope of the invention.

What is claimed is:

1. A computer-implementable method for implementing quick response replies on a data processing system, said computer-implementable method comprising:
drafting a current message within a current window, wherein said current message is targeted to a current user;
in response to receiving a new message while said current message is partially drafted, drafting a new reply message to respond to said new message while preserving said partially-drafted current message;
sending said new reply message to respond to said new message;
completing said partially-drafted current message to create a completed current message; and
sending said completed current message to said current user.

2. The computer-implementable method according to claim 1, wherein said drafting a new reply message further comprises:
inserting a predetermined character in said partially-drafted current message to represent a beginning of said new reply message; and
drafting said new reply message after said predetermined character to generate a combined message, wherein said combined message includes said partially-drafted current message, said predetermined character, and said new reply message.

3. The computer-implementable method according to claim 2, further comprising:
in response to sending said new reply message to respond to said new message, deleting said predetermined character and said new reply message from said combined message in said current window, thereby leaving said partially-drafted current message in said current window.

4. The computer-implementable method according to claim 1, wherein said drafting a new reply message further comprises:
generating a new window for drafting said new reply message; and
drafting said new reply message within said new window.

5. The computer-implementable method according to claim 4, further comprising:
in response to sending said new reply message, closing said new window.

6. A data processing system, comprising:
at least one processor;
an interconnect coupled to said at least one processor;
a computer-usable storage medium embodying computer program code, said computer-usable storage medium being coupled to said interconnect, said computer program code comprising instructions executable by said at least one processor and configured for:
drafting a current message within a current window, wherein said current message is targeted to a current user;
in response to receiving a new message while said current message is partially drafted, drafting a new reply message to respond to said new message while preserving said partially-drafted current message;
sending said new reply message to respond to said new message;
completing said partially-drafted current message to create a completed current message; and
sending said completed current message to said current user.

7. The data processing system according to claim 6, wherein said instructions configured for drafting a new reply message further comprises instructions configured for:
inserting a predetermined character in said partially-drafted current message to represent a beginning of said new reply message; and
drafting said new reply message after said predetermined character to generate a combined message, wherein said combined message includes said partially-drafted current message, said predetermined character, and said new reply message.

8. The data processing system according to claim 7, wherein said instructions are further configured for:
in response to sending said new reply message to respond to said new message, deleting said predetermined character and said new reply message from said combined message in said current window, thereby leaving said partially-drafted current message in said current window.

9. The data processing system according to claim 6, wherein said instructions for drafting a new reply message are further configured for:
generating a new window for drafting said new reply message; and
drafting said new reply message within said new window.

10. The data processing system according to claim 10, wherein said instructions are further configured for:
in response to sending said new reply message, closing said new window.

11. A computer-usable medium embodying computer program code, said computer program code comprising computer executable instructions configured for:
drafting a current message within a current window, wherein said current message is targeted to a current user;
in response to receiving a new message while said current message is partially drafted, drafting a new reply message to respond to said new message while preserving said partially-drafted current message;
sending said new reply message to respond to said new message;
completing said partially-drafted current message to create a completed current message; and
sending said completed current message to said current user.

12. The computer-usable medium according to claim 11, wherein said computer executable instructions for drafting a new reply message further comprises computer executable instructions configured for:
inserting a predetermined character in said partially-drafted current message to represent a beginning of said new reply message; and
drafting said new reply message after said predetermined character to generate a combined message, wherein said combined message includes said partially-drafted current message, said predetermined character, and said new reply message.

13. The computer-usable medium according to claim 12, wherein said embodied computer program code further comprises computer executable instructions configured for:
in response to sending said new reply message to respond to said new message, deleting said predetermined character and said new reply message from said combined message in said current window, thereby leaving said partially-drafted current message in said current window.

14. The computer-usable medium according to claim 11, wherein said computer executable instructions for drafting a new reply message further comprises computer executable instructions configured for:
generating a new window for drafting said new reply message; and
drafting said new reply message within said new window.

15. The computer-usable medium according to claim 14, wherein said embodied computer program code further comprises computer executable instructions configured for:
in response to sending said new reply message, closing said new window.
